(19) United States
(12) Patent Application Publication
(10) Pub. No.: US 2011/0054436 A1
(43) Pub. Date: Mar. 3, 2011

(54) Method and system for maintaining aseptic conditions in the storage of biologics

(76) Inventors: Jack C. Griffis, III, Decatur, GA (US); Minh Vo, Sugar Hill, GA (US)

(21) Appl. No.: 12/806,541

(22) Filed: Aug. 16, 2010

Related U.S. Application Data
(60) Provisional application No. 61/274,249, filed on Aug. 14, 2009.

(51) Int. Cl. A61J 1/22

(52) U.S. Cl. 604/407

(57) ABSTRACT

Technologies are generally described for the storage of biologics and other fluid materials while maintaining aseptic conditions. A system may include a storage body providing a reservoir for containing the materials. A cap may couple to the storage body forming a fluid-tight seal. A port may be provided for transferring the materials. A seal, or valve, may be provided within the port. The seal may be configured to close off the reservoir unless acted upon to release the materials through the port. A movable member may make up part of the storage body. The movable member may be configured to change a reservoir volume of the storage body in response to changes in a volume of the materials. The reservoir may become smaller as the materials are released. Multi-dose volumes of fluid materials may be stored for repeated access with reduced risk of contamination and reduction in shelf life.

### FIELD OF THE TECHNOLOGY

The present technology is generally related to maintenance and storage of biologics as it pertains to maintaining aseptic conditions, and more specifically to preventing contamination due to repeated access. The biologics can comprise drugs, cells in suspension or other solutions or fluids intended for aseptic storage and routine access. For example, an aseptic container can store human breast milk for repeated enteral feedings while minimizing the risk of contamination and increasing the shelf life of the milk.

### BACKGROUND

The storage of biological fluids and solutions is routine practice in biomedical applications today. However, shelf-life of these fluids and solutions can be compromised through contamination due to repeated access. Contamination can be minimized by storage of these fluids and solutions in single dose volumes, preventing the potential contamination by eliminating the risks posed by multiple accessing of the aseptic storage container. However, dosage volumes may not be predictable in all instances, and the increase storage space requirements associated with multitudes of single dose containers may not be feasible.

The current art lacks a reliable way to allow for the flexibility of dosing regimens and the reduction in storage complexity for biologic fluids and solutions as it relates to their prescription, administration and delivery. Moreover, the art lacks adequate systems and methods for reducing the risks associated with the manipulation, transport, handling, storage and/or repeated access of biologics whose aseptic condition may be sensitive to such actions. A technology addressing this need, or some other related technological deficit, would benefit practitioners.

In one aspect of the present invention, a means for storing multi-dose volumes of human breast milk can provide for repeated access of the biological fluid without the risk of contamination and subsequent reduction in shelf life. The discussion of maintenance of aseptic conditions in multi-dose volumes of human breast milk presented in this summary is for illustrative purposes only. Various aspects of the present invention may be more clearly understood and appreciated from a review of the following detailed description of the disclosed embodiments and by reference to the figures and claims. Other aspects, systems, processes, methods, features, advantages, benefits, and objects of the present invention will become apparent to one of ordinary skill in the art upon examination of the following detailed description and the accompanying figures. It is intended that all such aspects, systems, processes, methods, features, advantages, benefits, and objects are to be included within this description, are to be within the scope of the present invention, and are to be protected by the accompanying claims.

### BRIEF DESCRIPTION OF THE FIGURES

FIG. 1A is a prospective view of the aseptic container assembly, shown with cap open and main body ready for attachment to fluid transfer component (i.e.—breast pump, etc.)

FIG. 1B is a side view of the same assembly showing section A-A

FIG. 1C is a section view A-A of the assembly shown in FIG. 1B showing the assembly with the cap off and the plunger in the topmost position; indicating that the aseptic container is empty.

FIG. 2A is a prospective view of the aseptic container assembly, shown with cap closed; indicating that the aseptic container has been filled with the fluid intended for storage and/or repeated access.

FIG. 2B is a side view of the same assembly showing section B-B

FIG. 2C is a section view B-B of the assembly shown in FIG. 2B showing the assembly with the cap on and the plunger in the bottom most position; indicating that the aseptic container is full and showing detail view C.

FIG. 2D is a detail view C of the section view B-B of the assembly shown in FIG. 2B showing the assembly with a ball valve in the closed position. Said ball valve is configured such that in the closed position it rests in a sealed position against the top inside surface of the cap, preventing contaminants from entering the aseptic container.

FIG. 3A is a prospective view of the aseptic container assembly showing access by a standard syringe. The syringe is inserted into the container cap such that the tip of the syringe is flush with the ball valve.

FIG. 3B is a side view of said assembly showing section D-D

FIG. 3C is a section view D-D of said assembly, showing the syringe tip fully engaged against the ball plunger, and the plunger in the topmost position; indicating that the aseptic container has been emptied and showing detail view E.

FIG. 3D is a detail view E of section view D-D of the assembly in

FIG. 3B showing the syringe barrel fully engaged against the ball valve, the ball valve spring fully compressed and the syringe barrel tip flush with the inside surfaces of the aseptic container cap; ensuring no outside contaminants can enter the cap exchange interface during repeated access by the syringe.

FIG. 4A is a side view of an alternate embodiment of the aseptic container and showing section F-F and with the assembly cap closed.

FIG. 4B is a section view F-F of the aseptic container assembly in FIG. 4A showing the alternate embodiment of the aseptic container full and the duckbill valve and ball valve combination of the cap as indicated by detail view G.

FIG. 4C is a detail view G of the cap assembly with combination valve show in section view F-F of FIG. 4B. The ball valve is closed such that the outside surface is flush with the inside surface of the cap tip and the duckbill valve is flush with the outside surface of the bottom stem of the ball valve; preventing contamination on two levels.

FIG. 4D is an alternate view of the assembly in FIG. 4A showing section view H-H.

FIG. 4E is a section view H-H of the assembly shown in FIG. 4C showing an alternate view of the aseptic container cap assembly with combination valve and detail view I.

FIG. 4F is a detail view I of section view H-H showing the ball valve and duckbill valve assembly in the closed position. The ball valve is configured such that is can slidably engage the duckbill valve during repeated access while maintaining the duckbill valve in a closed position; especially under positive pressure, thus preventing the introduction of contaminants through the ball valve when under pressure.

FIG. 5A is a side view of the alternate embodiment shown in FIG. 4A as engaged by a syringe barrel during repeated access and showing section view J-J.

FIG. 5B is a section view J-J of the assembly shown in FIG. 5A showing the syringe barrel fully engaged with the ball valve, and the duckbill valve open due to evacuation of the aseptic container due to withdrawal of the syringe plunger; allowed only by the full engagement of the ball valve by the syringe barrel tip and as showing detail view K.

FIG. 5C is the detail view K of section view J-J showing the combination valve as fully engaged by the syringe barrel tip and with the duckbill valve open during aspiration, allowing removal of the fluids stored within the aseptic container while preventing introduction of contaminants during withdrawal.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

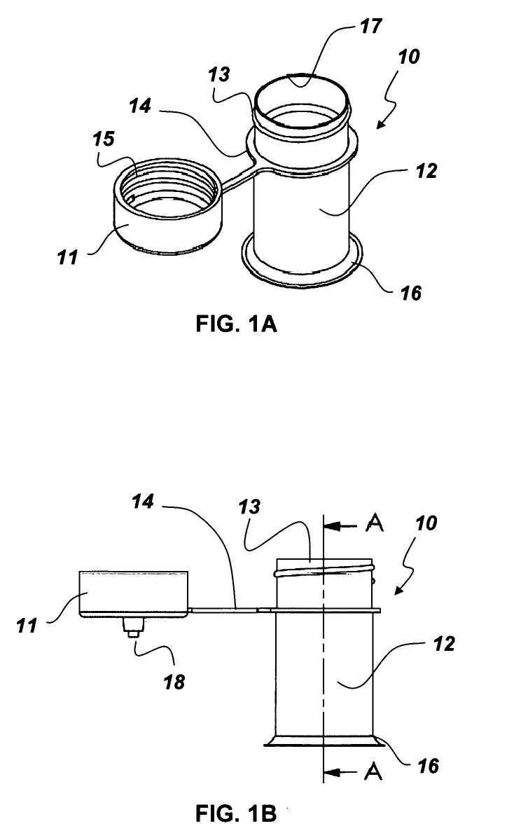

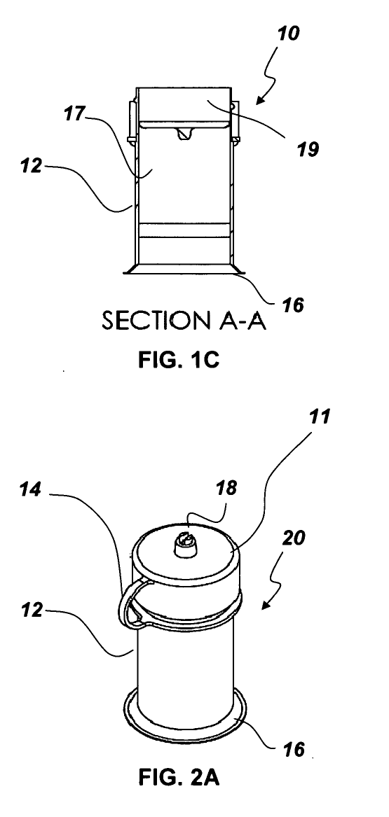

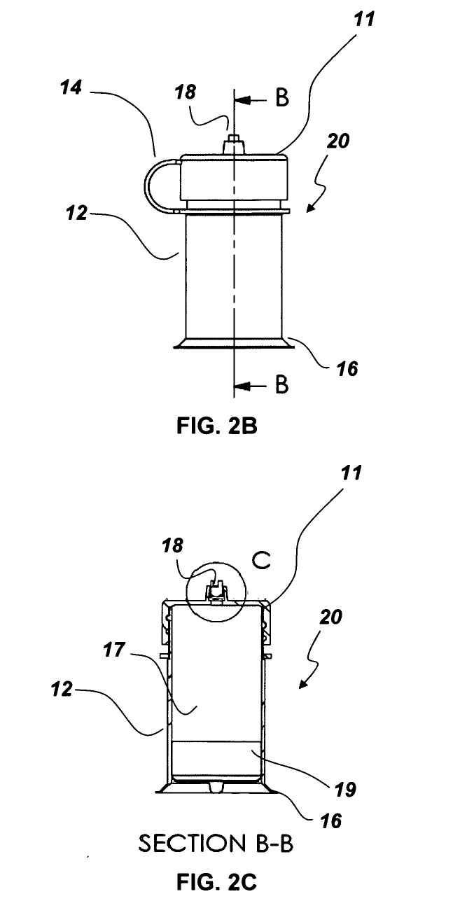

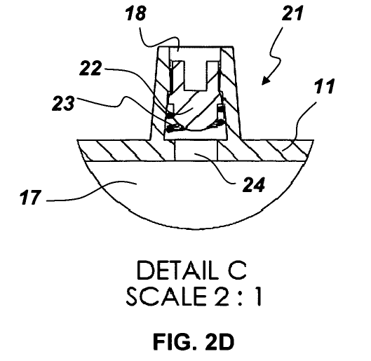

Referring now to FIGS. 1-2, an aseptic container assembly 10 is shown according to a first example embodiment that supports storage for repeated access while minimizing exposure of a biological agent to contamination. Those skilled in the art having benefit of this disclosure will appreciate that, beyond addressing repeated access of the biologics contained therein and the impact of contamination to the biologics due to said repeated access, the present technology and the aseptic container 10 address further needs in the art, for example providing storage and repeated access finesse even for biological agents that are not susceptible to contamination.

The term “contaminate”, as used herein, generally refers to: a foreign or non-sterile material, with resulting impact of limiting the usable life of the biologics stored within the aseptic container. The term “contamination,” as used herein, generally encompasses the act of introducing a foreign or non-sterile material during repeated access of the biologics, with resulting impact of limiting the usable life of the biologics stored within the aseptic container.

Those skilled in the art having benefit of this disclosure will appreciate that a biological fluid or other agent maintained in solution (such as, but not limited to; cells in suspension or human breast milk) stored within an aseptic container and intended for repeated access is prone to contamination due to exposure to non-sterile conditions or the introduction of non-sterile materials during said access. While the repeated access of said biologics in standard aseptic containers is commonly conducted using sterile access devices, contamination can still occur due to the lack of proper sealing of the container after said access, or due to the introduction of contamination materials that may be present on the surface of said container during introduction of the access device.

Examples of biological agents include; living cells in suspension; therapeutic cells (stem cells, progenitor cells or cells having a capability to differentiate into a specific type of cell); drugs; pharmaceutical agents; one or more pharmacologically active ingredients disposed in a delivery solution; drug carrier systems; biochemicals susceptible to various storage conditions; carbohydrate compounds and materials in solution; and various biological fluids such as, but not limited to, human breast milk, etc., without being exhaustive.

The aseptic container 10 comprises a storage body comprised of a generally elongate cylindrical form 12 having a distal enclosed end or base 16, a proximal open end 13, and an internal surface 17 extending there through. The body 12 can be constructed of a biocompatible material such as but not limited to silicone rubber, polyurethane, polyethylene, thermoplastic elastomers, or any other suitable polymer or material. The distal enclosed end 16 of the storage body 12 includes a movable member at the end of the lumen 19. This movable member 19 is also constructed of biocompatible material such as but not limited to silicone rubber, polyurethane, polyethylene, thermoplastic elastomers, or any other suitable polymer or material. The enclosed end may take many forms other than those shown in the figures, including but not limited to; collapsible bag, translational body, pressurized assembly, etc., without being exhaustive.

For certain applications, the storage body 12 can be sized for connection to standard collection apparatus for biological fluids such as human breast milk via the open end 13. The open end can take the form of locking threads, snap connection, etc., without being exhaustive. The geometry of the storage body is sufficient to provide adequate storage volume for the biologic during transfer from the origin into the aseptic container, but can vary depending on application. The section view FIG. 1C shows the empty aseptic storage container 10 such that the distal movable member 19 is withdrawn and fully proximal such that the minimum enclosed volume is displayed.

The storage body 12 further includes a tethered cap 11 placed adjacent to the storage body 12, either permanently affixed or attached via some form of connection umbilical 14. The cap 11 has a large inner and outer diameter than the storage body 12. The cap 11 is affixed to the storage body 12 such that it can be applied to the proximal open end 13 of the storage body 12 without difficult manipulation. The cap 11 is aligned with the storage body 12 and defines the means for enclosing the biologics within the storage body 12 once the aseptic container 10 is full or ready for storage. The cap 11 includes a means to access the biologics contained within the storage body 12 via a seal 18 on the top of the cap. The seal 18 prevents access of contaminants there through. The cap, as shown in FIG. 2, can be integrally connected to the storage body 12 such that it forms a fluid tight assembly 20.

The inner surface 17 defines a sterile, biologic storage space, chamber or reservoir 17, which contains the biologic during storage and repeated access via the seal 18 and protects the biologic from contamination encountered during access of the biologic through the seal 18. The seal 18 can be constructed of biocompatible surface contact sealing materials, such as thermoplastic elastomers, silicone, polyisoprene or other appropriate materials that, when pressed against a surface of greater rigidity, provide a fluid tight seal. When accessed, the seal 18 provides for the means to withdraw the biologics from the storage body 12 such that the distal movable member 19 retracts and reduces the total available volume of the aseptic container accordingly. This corresponding change in container volume prevents the formation of internal vacuum during withdraw of the biologic, thereby eliminating the potential for introduction of contaminants due to the need to normalize with ambient conditions.

FIG. 2C is a section view of the capped aseptic container assembly 20 and shows the aseptic container 20 filled to capacity such that the distal movable member 19 is fully distal such that the maximum enclosed volume is displayed. FIG. 2D shows a detail view of the section view 2C for the seal 18. Proximate the seal 18 are one or more holes, apertures, or passageways 24 through the cap 11 providing entry into the enclosed aseptic container 20 and around the seal 22. The plurality of holes 24 permits the movement of the biologic between the inner sterile surfaces 17 and the outer cap 11 during access and movement of the seal 22.

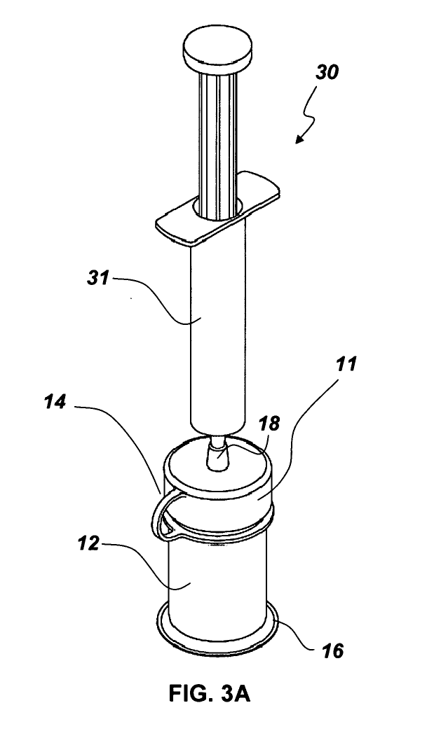

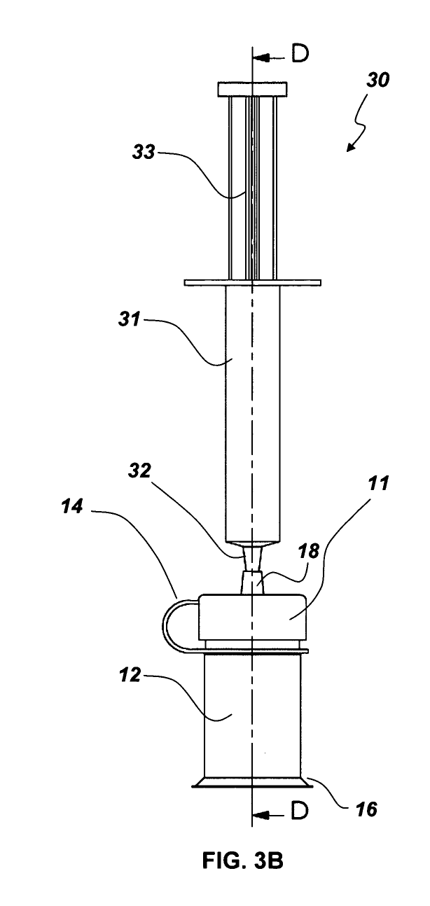

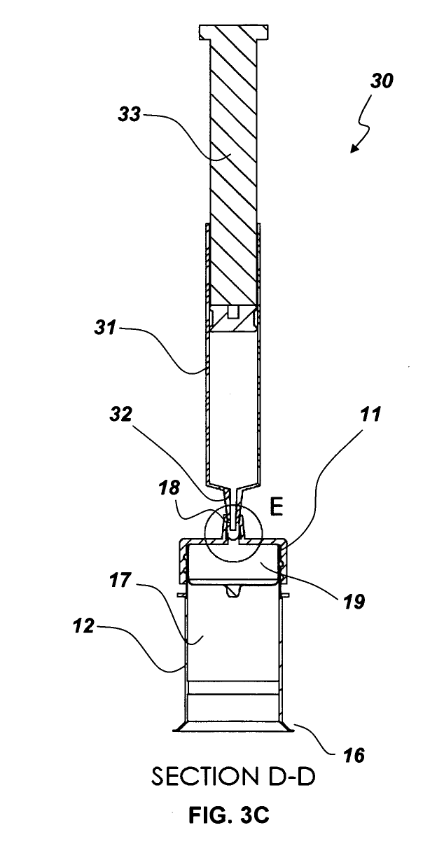

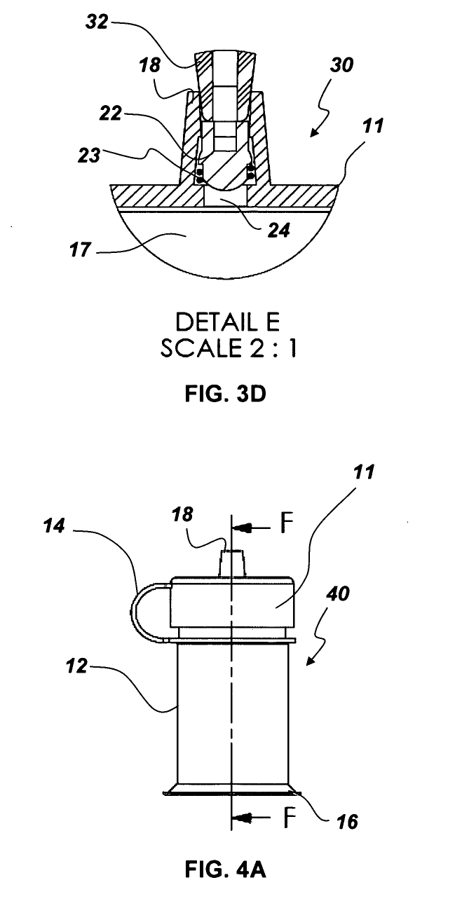

Accordingly, fluid in the inner storage body 12 can flow through the holes 24 and the seal 18 and into the intermediate transport vessel 31 and as shown, and hereby referred to as, a needleless syringe format in FIG. 3. However, when the nozzle 32 of the needless syringe 31 is inserted into the seal 18 to access the storage biologic, the syringe 31 at least substantially, if not fully, occludes the exit of the seal 18 thereby preventing inadvertent expulsion of the biologic during access as shown in FIGS. 3C and 3D. FIG. 3C is a section view of FIG. 3B showing the connection of the needless syringe 31 to the aseptic container 10 via insertion of the nozzle 32 into the seal 18. FIG. 3D is a detail view of the section view in FIG. 3C showing the placement of the syringe 31 nozzle 32 within the seal 18. Additionally, the path through the holes 24 can be opened only upon access with the nozzle 31 such that it has depressed the seal 22 sufficiently to eliminate the fluid tight seal previously maintained prior to access. The seal return 23 is shown compressed such that the seal 22 can be returned to its nominal state upon removal of the nozzle 32. The seal return can be comprised of biocompatible material such as stainless steel compression springs, shape memory alloys such as nickel titanium, elastomeric polymers or other similar materials.

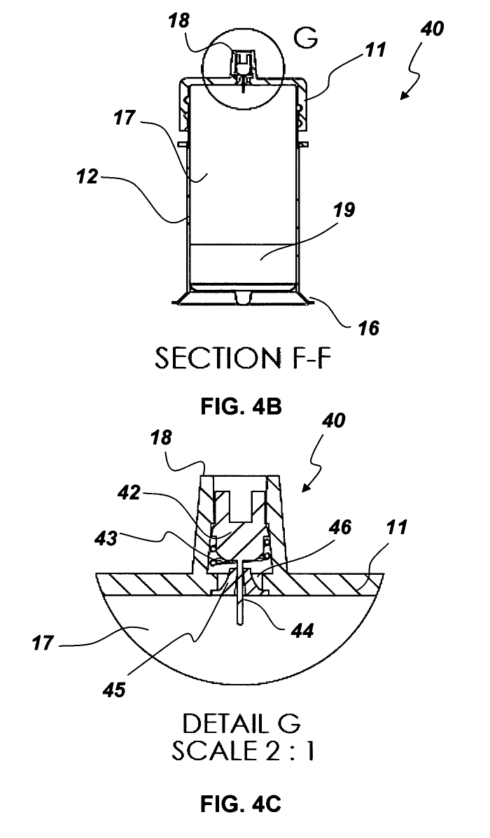

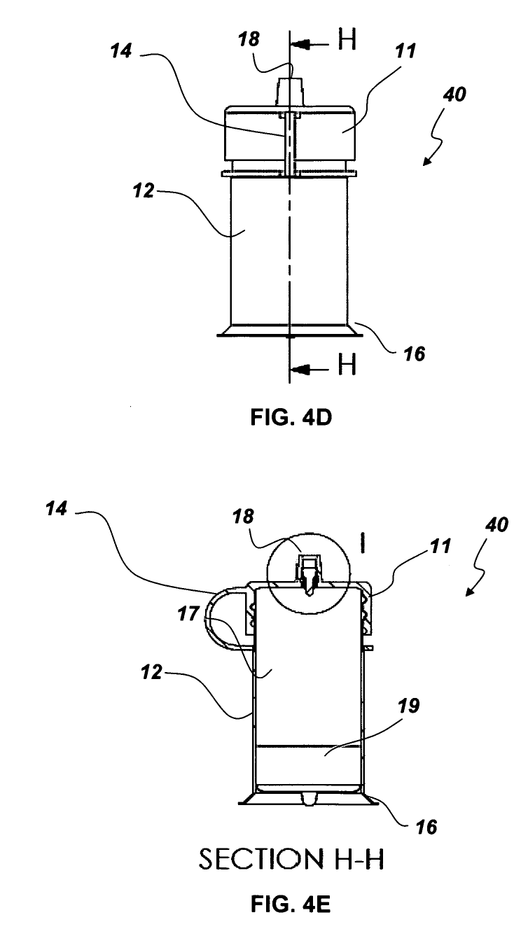

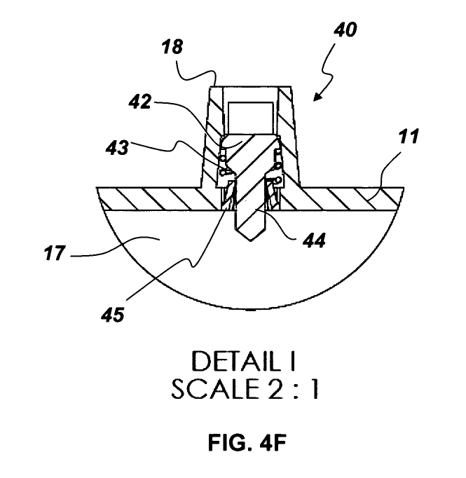

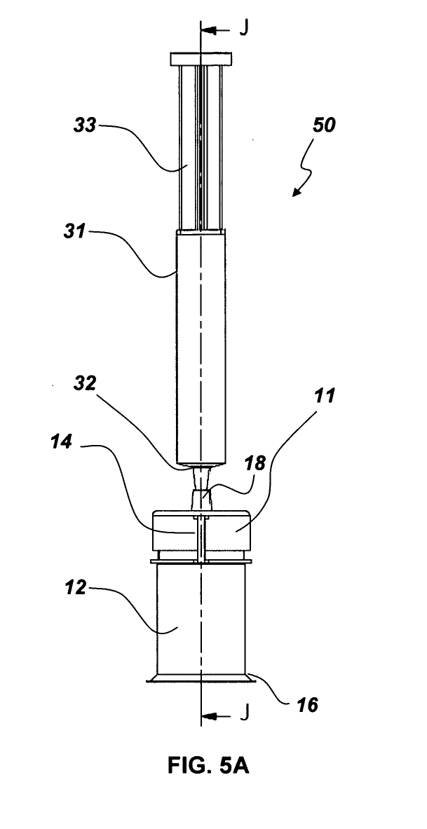

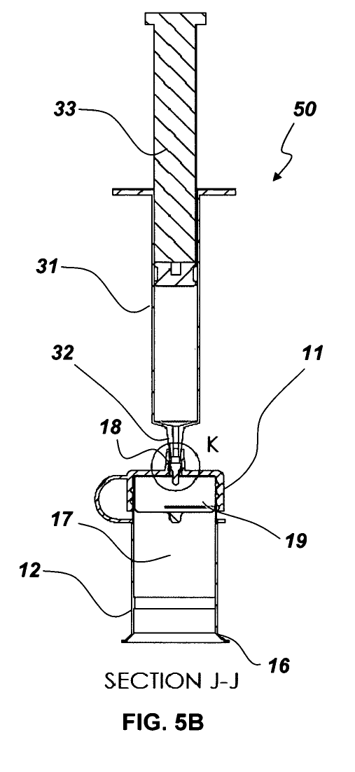

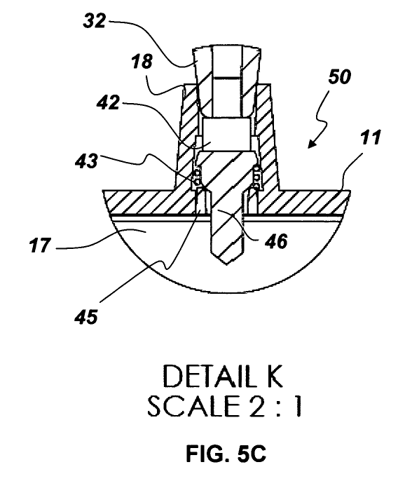

FIGS. 4 and 5 show alternate views of the aseptic container 40 with internal self-penetrating components attached to the seal 18. In this embodiment, and as shown in the detail view FIG. 4C of the section view FIG. 4B, the seal body 42 includes an asymmetric self penetrating feature 44 that pushes through an integral seal 45 built into the cap 11 aperture 46. This asymmetric self penetrating feature is shown in the opposing plane in the detail view FIG. 4E of the section view FIG. 4D. In this view, the self penetrating feature is shown across the seal 45, but such that said seal 45 provides a fluid tight seal against the feature 44 when the seal body 42 is fully engaged with the seal 18 via the seal return component 43.

In FIG. 5, the aseptic container assembly 50 is accessed by the needless syringe 31 such that the nozzle 32 is fully engaged with the cap 11 seal 18. FIG. 5C shows a detail view of the section view in FIG. 5B. This detail view displays the accessed aseptic container assembly 50 such that the nozzle 32 is fully engaged with the seal 18. In this view, the seal body 42 is depressed such that the integral seal 45 is moved away from the seal body 42 and the penetrating feature 46 is fully within the sterile internal storage space 17 and provides for passage of the biologic container therein past the integral seal 45, around the asymmetric seal body 42 and into the needless syringe 31. Similarly to the action shown in FIG. 3, the practitioner withdraws the plunger of the syringe 33 to cause the biologic to flow from the aseptic storage container 50 into the needless syringe 31. To adjust for the change in fluid volume the distal movable member 19 compensates by altering its position or geometry within the storage body 12 to adjust the volume within the storage body 12 to thereby keep the biologic within the sterile storage space 17 without causing the formation of differential pressure such that a vacuum occurs within the storage body 12, thereby increasing the likelihood of the flow of contaminants into the sterile storage space 17.

While the invention has been described with reference to example embodiments, it will be understood by those skilled in the art that a variety of modifications, additions and deletions are within the scope of the invention, as defined by the following claims.

1. (canceled)

2. A system for storing fluid materials, the system comprising:
a storage body;
a reservoir within the storage body configured for containing the materials;
a cap configured to removably couple to the storage body;
a port positioned within the cap;
a seal, positioned within the port, configured to close off the reservoir unless acted upon to release the materials through the port; and
a movable member, within the storage body, configured to support changing a volume associated with the reservoir in response to change in a volume associated with the materials.

3. The system of claim 2, wherein the seal comprises a valve.

4. The system of claim 2, wherein the seal comprises a ball valve.

5. The system of claim 2, wherein the seal comprises a duckbill valve.

6. The system of claim 2, wherein the seal comprises a seal return configured to hold the seal closed when not being acted upon from outside.

7. The system of claim 6, wherein the seal return comprises a spring.

8. The system of claim 2, wherein the seal is configured to be actuated by a syringe to support release of the materials from the reservoir into the syringe.

9. The system of claim 2, wherein the port is configured to couple to a syringe while supporting a substantial elimination of transferred contaminants into the reservoir.

10. The system of claim 2, wherein the seal comprises a self penetrating feature.

11. The system of claim 10, wherein the seal comprises an integral seal positioned around the self penetrating feature.

12. The system of claim 2, wherein the materials comprise biologic materials.

13. The system of claim 2, wherein the materials comprise human breast milk.

14. The system of claim 2, wherein the movable member supports removal of the materials through the port with reduced partial vacuum generation.

15. The system of claim 2, wherein the movable member comprises a plunger.

16. The system of claim 2, wherein the movable member comprises a pressurized assembly.

17. The system of claim 2, wherein the movable member comprises a collapsible bag.

18. A method for accessing fluid materials within a reservoir formed by a storage body, a movable member, and a cap having a port with a valve, the method comprising:
coupling to the port as to prevent contaminants from entering the reservoir;
engaging the valve;
transferring the fluid materials out of the reservoir through the port in response to the valve being engaged;
operating the movable member to reduce a volume of the reservoir in response to transferring the fluid materials out of the reservoir through the port; and
sealing the valve in response to decoupling from the port.

19. The method of claim 18, wherein engaging the valve comprises depressing a syringe against the valve.

20. The method of claim 18, further comprising engaging a self penetrating feature in response to engaging the valve.

21. A system for storing human breast milk, the system comprising:
a storage body;
a reservoir within the storage body configured for containing the milk;
a movable member, within the storage body, configured to reduce a volume associated with the reservoir in response to release of the milk from the reservoir;
a cap configured to removably couple to the storage body;
a port positioned within the cap; and
a seal, positioned within the port, comprising a ball valve and a seal return spring configured to hold the seal closed when not being actuated, wherein the seal is configured to be actuated to support a release of the milk from the reservoir.
